(19) United States
(12) Patent Application Publication
(10) Pub. No.: US 2024/0003076 A1
(43) Pub. Date: Jan. 4, 2024

(54) MOBILE LAUNDRY ORGANIZATION DEVICE

(71) Applicant: Jawaun Shabazz, Lindon, NJ (US)

(72) Inventor: Jawaun Shabazz, Lindon, NJ (US)

(21) Appl. No.: 17/853,856

(22) Filed: Jun. 29, 2022

(51) Int. Cl. D06F 95/00; B67D 3/00; B62B 1/10

(52) U.S. Cl. CPC D06F 95/002; B67D 3/0083; B62B 1/10; B62B 2202/65

(57) ABSTRACT

A mobile laundry organization device for organizing clean and dirty laundry includes a bin. The bin has a cylindrical shape with a top end and a bottom end. The bin has an interior defining a space for a variety of elements to be positioned within. A bottom base is in a fixed position on the bottom end of the bin and a top base is connected to the top end of the bin. The top base secures by slide fastening to the top end wherein enclosing the interior of the bin. A pair of inserts is nested within the interior of the bin to create a plurality of cavities. Additionally, a pair of containers is positioned on the exterior of the bin holds a liquid laundry detergent. A cart is attached upon the bottom base of the bottom end of the bin to provide mobility to the bin.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to laundry hamper device and more particularly pertains to a new laundry hamper device for organizing clean and dirty laundry.

### (2) Description of Related Art Including Information Disclosed Under 37 CFR 1.97 and 1.98

The prior art relates to laundry hamper devices. The prior art relates to a variety of laundry hamper devices having either a plurality of cupboards or a top enclosure and being portable. Known prior art lacks a laundry hamper device having a plurality of pockets and a top enclosure configured for organizing the laundry and being portable.

### BRIEF SUMMARY OF THE INVENTION

An embodiment of the disclosure meets the needs presented above by generally comprising a bin. The bin has a cylindrical shape with a top end and a bottom end. The bin has an exterior surface and an interior surface. Furthermore, the bin has an interior defining a space for a variety of elements to be positioned within. A bottom base is in a fixed position on the bottom end of the bin and encloses the interior of the bin. A top base is coupled to the top end of the bin by a hinge flap and is configured for engaging by slide fastening to the top end of the bin wherein enclosing the interior of the bin. A handle is positioned on the exterior surface of the bin and is configured for being grabbed by a user. A pair of inserts is nested within the interior of the bin. The pair of inserts is configured for producing a plurality of cavities within the interior of the bin. A plurality of pockets is positioned on the exterior surface of the bin. Additionally, a pair of containers is positioned on the exterior of the bin. Each of the containers has an inside defining a space for holding a liquid laundry detergent. Each of the containers has a spout being configured for flowing out the liquid laundry detergent from the inside of each of the containers. A cart is attached upon the bottom base of the bottom end of the bin. The cart has a top surface and a bottom surface wherein a protrusion is position on the bottom surface of the cart and extends outward. The protrusion has a pair of wheels wherein the cart is configured for providing mobility to the bin.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a mobile laundry organization device according to an embodiment of the disclosure.

FIG. 2 is a rear view of an embodiment of the disclosure.

FIG. 3 is a left side view of an embodiment of the disclosure.

FIG. 4 is an exploded view of an embodiment of the disclosure.

FIG. 5 is a front isometric view of an embodiment of the disclosure.

### DETAILED DESCRIPTION OF THE INVENTION

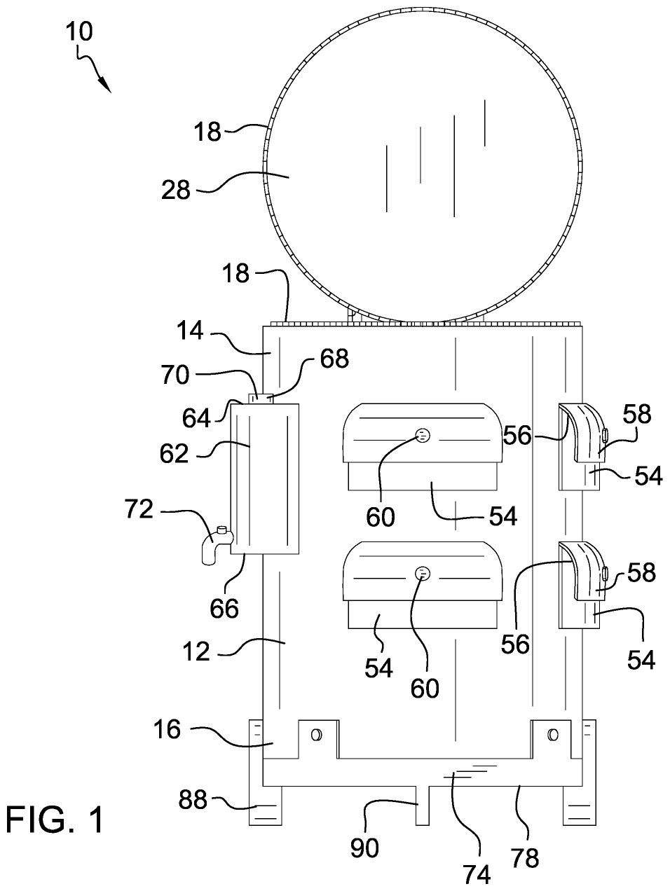

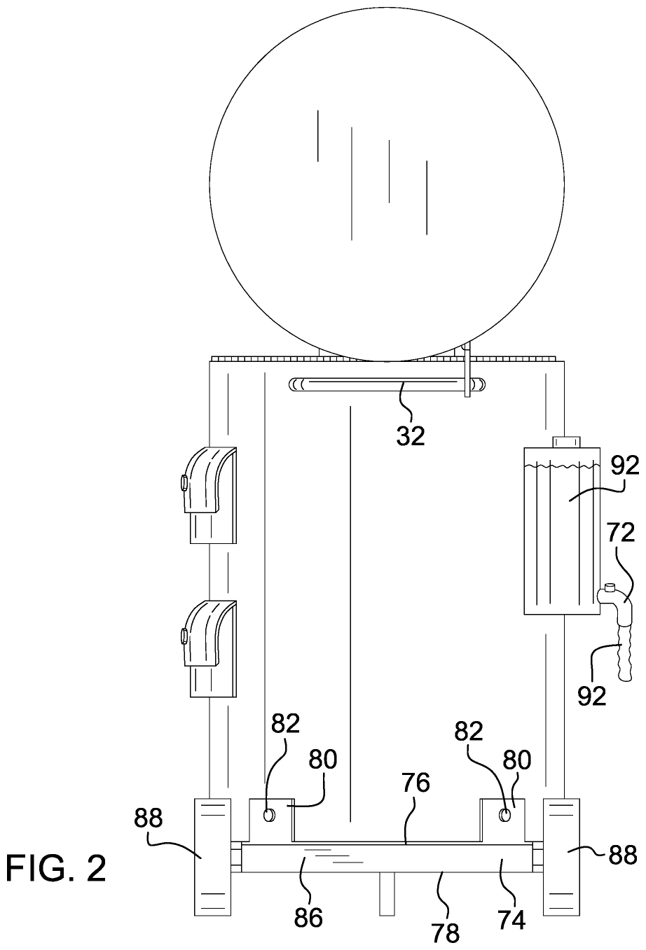

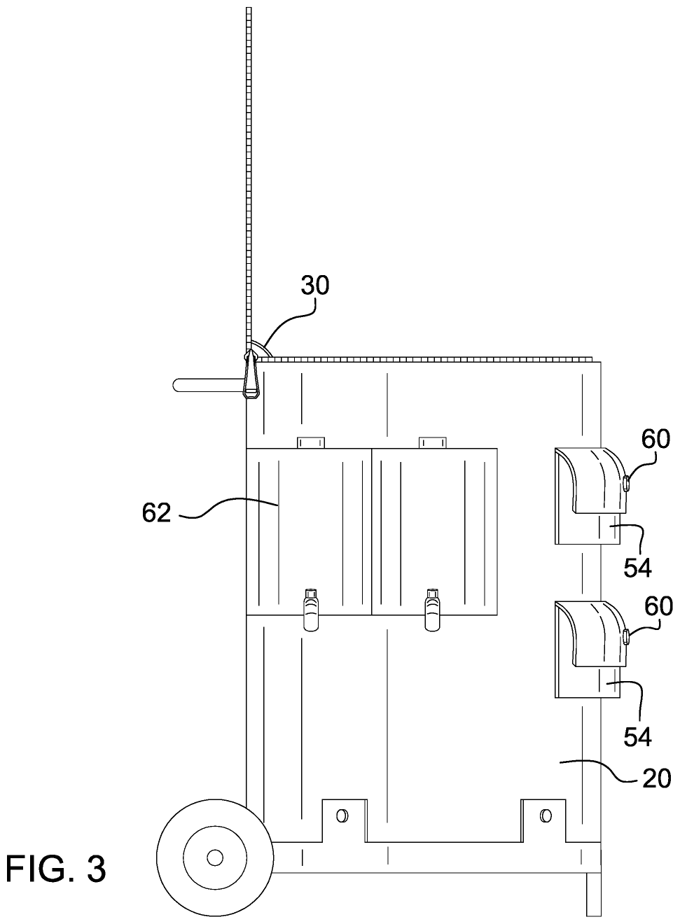

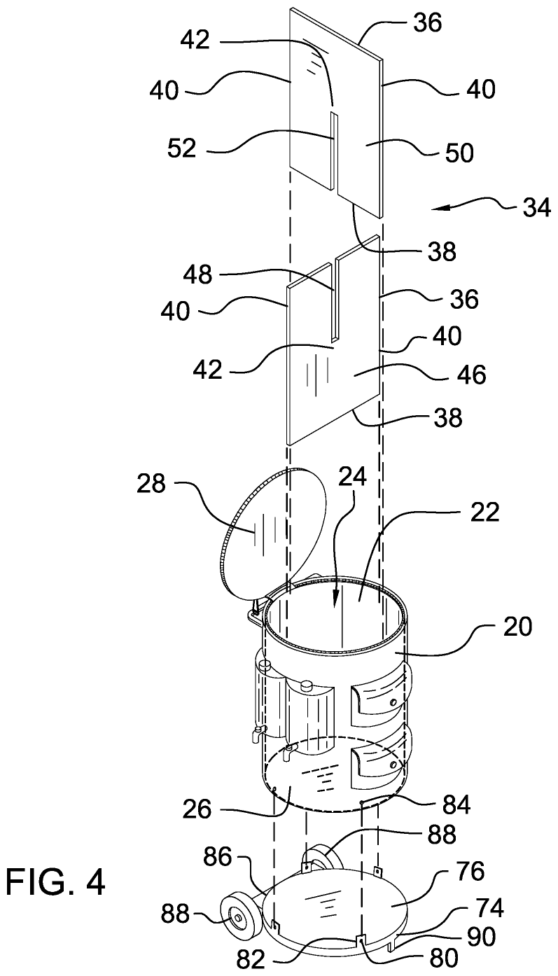

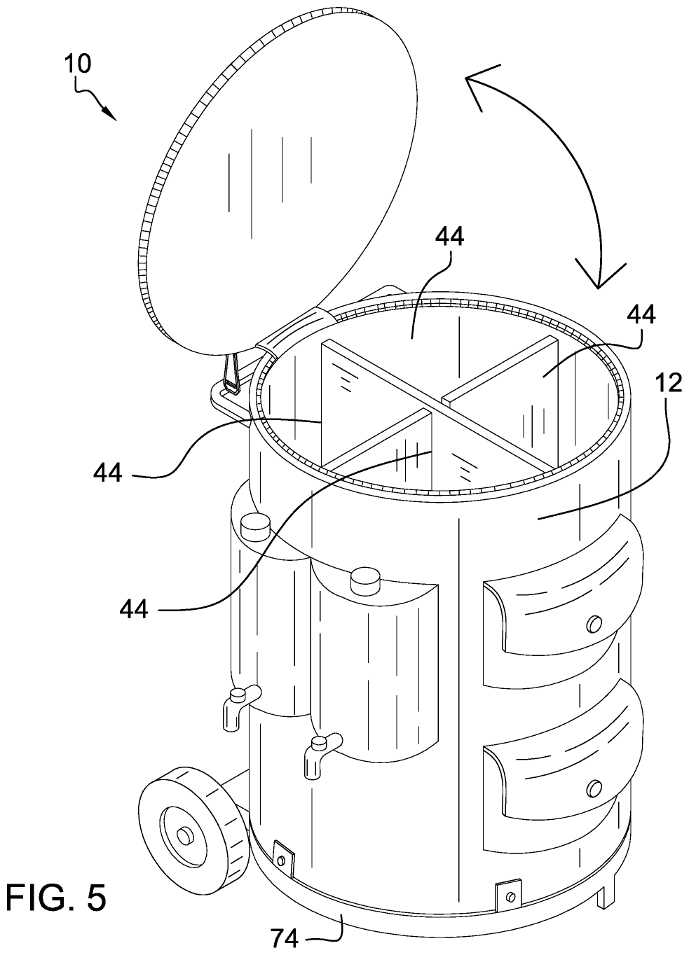

With reference now to the drawings, and in particular to FIGS. 1 through 5 thereof, a new laundry hamper device embodying the principles and concepts of an embodiment of the disclosure and generally designated by the reference numeral 10 will be described.

As best illustrated in FIGS. 1 through 5, the mobile laundry organization device generally comprises a bin 12. The bin 12 has a cylindrical shape with a top end 14 and a bottom end 16. The top end 14 has a first portion of a slide fastener 18. Additionally, the bin 12 has an exterior surface 20 and an interior surface 22. A plurality of snaps 84 is positioned on the exterior surface 20 of the bin 12 and is positioned proximate to the bottom end 16 of the bin 12. The bin 12 has an interior 24 defining a space for a variety of elements to be positioned within.

A bottom base 26 is in a fixed position on the bottom end 16 of the bin 12. The bottom base 26 is circular and enclosing the interior 24 of the bin 12. A top base 28 is coupled to the top end 14 of the bin 12 by a hinge flap 30. The hinge flap 30 positions the top base 28 from an open position to a closed position relative to the top end 14 of the bin 12. The top base 28 is circular and has a second portion of the slide fastener 18. The top base 28 is configured for engaging by the slide fastening 18 to the top end 14 of the bin 12 wherein enclosing the interior 24 of the bin 12. In addition, a handle 32 is positioned on the exterior surface 20 of the bin 12. The handle 32 is positioned proximate to the hinge flap 30 of the top end 14 of the bin 12 and is configured for being grabbed by a user.

A pair of inserts 34 is nested within the interior 24 of the bin 12. Each of the inserts 34 has a rectangular prism shape with a top edge 36 and a bottom edge 38. Each of the inserts 34 has a pair of lateral edges 40 is positioned against the interior surface 22 of the bin 12. In addition, each of the inserts 34 has a center 42. The pair of inserts 34 is configured for producing a plurality of cavities 44 within the interior 24 of the bin 12. The pair of inserts 34 further includes a first insert 46. The first insert 46 has an indent 48 positioned from the top edge 36 to the center 42. The bottom edge 38 of the first insert 46 is positioned against the bottom base 26 of the bin 12. A second insert 50 has an indent 52 positioned from the bottom edge 38 to the center 42. The top edge 36 of the second insert 50 is positioned proximate to the top end 14 of the bin 12. The indent 52 of the second insert 50 is positioned within the indent 48 of the first insert 46 wherein the top edge 36 of each of the inserts 34 is positioned flush relative to each other. The second insert 50 is configured for being positioned perpendicular relative to the first insert 46.

A plurality of pockets 54 is positioned on the exterior surface 20 of the bin 12. Each of the pockets 54 has an opening 56, and the opening 56 of each of the pockets 54 has a flap 58. The flap 58 of each of the pockets 54 is configured for retaining to the opening 56 of each of the pockets 54 by a snap clasp fastening 60. Additionally, a pair of containers 62 is positioned on the exterior surface 20 of the bin 12. Each of the containers 62 has an inside defining a space for holding a liquid laundry detergent 92. Each of the containers 62 has a top surface 64 and a bottom surface 66. A hole 68 and cap 70 are positioned on the top surface 64 of each of the containers 62. The cap 70 is configured for enclosing the hole 68 of each of the containers 62 and the cap 70 is removable. In addition, each of the containers 62 has a spout 72 being a conduit having a valve. The spout 72 of each of the containers 62 is positioned proximate to the bottom surface 66 of each of the containers 62 and each of the spouts 72 are configured for flowing out the liquid laundry detergent 92 from the inside of each of the containers 62.

A cart 74 is attached upon the bottom base 26 of the bottom end 16 of the bin 12. The cart 74 is circular and has a top surface 76 and a bottom surface 78. The top surface 76 of the cart 74 is positioned abutting the bottom base 26 of the bin 12. The top surface 76 of the cart 74 has a plurality of tabs 80 wherein each of the tabs 80 of the cart 74 has a button 82. The button 82 of each of the tabs 80 of the cart 74 is configured for engaging by snap button fastening to a respective one of each of the snaps 84 of the exterior surface of the bin 12 wherein retaining the cart 74 to the bin 12. A protrusion 86 is position on the bottom surface 78 of the cart 74 and extends outward so that the protrusion 86 is positioned coplanar to the handle 32 of the bin 12. The protrusion 86 has a pair of wheels 88 wherein each of the wheels 88 is rotatable relative to the protrusion 86. Moreover, the cart 74 is configured for providing mobility to the bin 12. A leg 90 is positioned on the bottom surface 78 of the cart 74 and is configured for providing stability to the bin 12 in an upright position when the pair of wheels 88 is not in-use.

In use, the first insert 46 the pair of inserts 34 nested within the interior 24 the bin 12 to create the plurality of cavities 44. Each of the cavities 44 is used to separate and organize clothes from laundry. The second insert 50 of the pair of inserts 34 can be nested within the interior 24 of the bin 12 further expand the plurality of cavities 44. The top base 28 can be secured to the top end 14 of the bin 12 by engaging the slide fastening 18 of the top end 14 of the bin 12. A variety of laundry accessories can be stored within the plurality of pockets 54 of the exterior surface 20 of the bin 12. The liquid laundry detergent 92 can be stored within each of the containers 62 wherein the spouts 72 of each of the containers 62 can distribute the liquid laundry detergent 92 when needed. The user can grab the handle 32 of the bin 12 prior to tilting the bin 12 at an angle to engage the pair of wheels 88 of the cart 74 wherein providing mobility to the bin 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile laundry organization device configured for separating elements used with laundry, the mobile laundry organization device comprising:
a bin having a cylindrical shape, said bin having a top end and a bottom end, said bin having an exterior surface and an interior surface, said bin having an interior, said interior defining a space for a variety of elements to be positioned within;
a bottom base being in a fixed position on said bottom end of said bin, said bottom base enclosing said interior of said bin;
a top base being coupled to said top end of said bin by a hinge flap, said top base being configured for engaging by slide fastening to said top end of said bin wherein enclosing said interior of said bin;
a handle being positioned on said exterior surface of said bin, said handle being configured for being grabbed by a user;
a pair of inserts being nested within said interior of said bin, said pair of inserts being configured for producing a plurality of cavities within said interior of said bin;
a plurality of pockets being positioned on said exterior surface of said bin;
a pair of containers being positioned on said exterior surface of said bin, each of said containers having an inside defining a space for holding a liquid laundry detergent, each of said containers having a spout, said spout of each of said containers being configured for flowing out said liquid laundry detergent from said inside of each of said containers;
a cart being attached upon said bottom base of said bottom end of said bin, said cart having a top surface and a bottom surface, a protrusion being position on said bottom surface of said cart and extending outward, said protrusion having a pair of wheels, said cart being configured for providing mobility to said bin.

2. The mobile laundry organization device of claim 1, further comprising said top end having a first portion of a slide fastener, said bin having a plurality of snaps positioned on said exterior surface and positioned proximate to said bottom end of said bin.

3. The mobile laundry organization device of claim 1, further said bottom base being circular.

4. The mobile laundry organization device of claim 2, further comprising said hinge flap positioning said top base from an open position to a closed position relative to said top end of said bin, said top base being circular, said top base having a second portion of said slide fastener.

5. The mobile laundry organization device of claim 1, further comprising said handle being positioned proximate to said hinge flap of said top end of said bin.

6. The mobile laundry organization device of claim 4, further comprising each of said inserts having a rectangular prism shape, each of said inserts having a top edge and a bottom edge, each of said inserts having a pair of lateral edges being positioned against said interior surface of said bin, each of said inserts having a center.

7. The mobile laundry organization device of claim 6, further comprising a first insert of said pair of inserts having an indent positioned from said top edge to said center, said bottom edge of said first insert being positioned against said bottom base of said bin.

8. The mobile laundry organization device of claim 7, further comprising a second insert of said pair of inserts having an indent positioned from said bottom edge to said center, said top edge of said second insert being positioned proximate to said top end of said bin, said indent of said second insert being positioned within said indent of said first insert wherein said top edge of each of said inserts being positioned flush relative to each other, said second insert being configured for being positioned perpendicular relative to said first insert.

9. The mobile laundry organization device of claim 1, further comprising each of said pockets having an opening, said opening of each of said pockets having a flap, said flap of each of said pockets being configured for retaining to said opening of each of said pockets by a snap clasp fastening.

10. The mobile laundry organization device of claim 1, further comprising each of said containers having a top surface and a bottom surface, a hole and a cap being positioned on said top surface of each of said containers, said cap being configured for enclosing said hole of each of said containers, said cap being removable.

11. The mobile laundry organization device of claim 10, further comprising said spout being a conduit having a valve, said spout of each of said containers being positioned proximate to said bottom surface of each of said containers.

12. The mobile laundry organization device of claim 1, further comprising said cart being circular.

13. The mobile laundry organization device of claim 12, further comprising said top surface of said cart being positioned abutting said bottom base of said bin, said top surface of said cart having a plurality of tabs, each of said tabs of said cart having a button, said button of each of said tabs of said cart being configured for engaging by snap button fastening to a respective one of each of said snaps of said exterior surface of said bin wherein retaining said cart to said bin.

14. The mobile laundry organization device of claim 13, further comprising said protrusion being positioned coplanar to said handle of said bin, said protrusion having a pair of wheels.

15. The mobile laundry organization device of claim 14, further comprising each of said wheels being rotatable relative to said protrusion.

16. The mobile laundry organization device of claim 15, further comprising a leg being positioned on said bottom surface of said cart, said leg being configured for providing stability to said bin in an upright position.

17. A mobile laundry organization device configured for separating elements used with laundry, the mobile laundry organization device comprising:
a bin having a cylindrical shape, said bin having a top end and a bottom end, said top end having a first portion of a slide fastener, said bin having an exterior surface and an interior surface, said bin having a plurality of snaps positioned on said exterior surface and positioned proximate to said bottom end of said bin, said bin having an interior, said interior defining a space for a variety of elements to be positioned within;
a bottom base being in a fixed position on said bottom end of said bin, said bottom base being circular, said bottom base enclosing said interior of said bin;
a top base being coupled to said top end of said bin by a hinge flap, said hinge flap positioning said top base from an open position to a closed position relative to said top end of said bin, said top base being circular, said top base having a second portion of said slide fastener, said top base being configured for engaging by said slide fastening to said top end of said bin wherein enclosing said interior of said bin;
a handle being positioned on said exterior surface of said bin, said handle being positioned proximate to said hinge flap of said top end of said bin, said handle being configured for being grabbed by a user;
a pair of inserts being nested within said interior of said bin, each of said inserts having a rectangular prism shape, each of said inserts having a top edge and a bottom edge, each of said inserts having a pair of lateral edges being positioned against said interior surface of said bin, each of said inserts having a center, said pair of inserts being configured for producing a plurality of cavities within said interior of said bin, said pair of inserts further including:
a first insert having an indent positioned from said top edge to said center, said bottom edge of said first insert being positioned against said bottom base of said bin; and
a second insert having an indent positioned from said bottom edge to said center, said top edge of said second insert being positioned proximate to said top end of said bin, said indent of said second insert being positioned within said indent of said first insert wherein said top edge of each of said inserts being positioned flush relative to each other, said second insert being configured for being positioned perpendicular relative to said first insert;
a plurality of pockets being positioned on said exterior surface of said bin, each of said pockets having an opening, said opening of each of said pockets having a flap, said flap of each of said pockets being configured for retaining to said opening of each of said pockets by a snap clasp fastening;
a pair of containers being positioned on said exterior surface of said bin, each of said containers having an inside defining a space for holding a liquid laundry detergent, each of said containers having a top surface and a bottom surface, a hole and a cap being positioned on said top surface of each of said containers, said cap being configured for enclosing said hole of each of said containers, said cap being removable, each of said containers having a spout, said spout being a conduit having a valve, said spout of each of said containers being positioned proximate to said bottom surface of each of said containers, said spout of each of said containers being configured for flowing out said liquid laundry detergent from said inside of each of said containers;
a cart being attached upon said bottom base of said bottom end of said bin, said cart being circular, said cart having a top surface and a bottom surface, said top surface of said cart being positioned abutting said bottom base of said bin, said top surface of said cart having a plurality of tabs, each of said tabs of said cart having a button, said button of each of said tabs of said cart being configured for engaging by snap button fastening to a respective one of each of said snaps of said exterior surface of said bin wherein retaining said cart to said bin, a protrusion being position on said bottom surface of said cart and extending outward, said protrusion being positioned coplanar to said handle of said bin, said protrusion having a pair of wheels, each of said wheels being rotatable relative to said protrusion, said cart being configured for providing mobility to said bin, a leg being positioned on said bottom surface of said cart, said leg being configured for providing stability to said bin in an upright position.
